(19) United States
(12) Patent Application Publication
(10) Pub. No.: US 2023/0192950 A1
(43) Pub. Date: Jun. 22, 2023

(54) THERMOPLASTIC RESIN AND OPTICAL MEMBER

(71) Applicant: TEIJIN LIMITED, Osaka-shi, Osaka (JP)

(72) Inventors: Tatsuya OOYAMA, Osaka-shi, Osaka (JP); Takatsune YANAGIDA, Osaka-shi, Osaka (JP); Yasuhiko TOMONARI, Osaka-shi, Osaka (JP)

(73) Assignee: TEIJIN LIMITED, Osaka-shi, Osaka (JP)

(21) Appl. No.: 17/919,088

(22) PCT Filed: Apr. 14, 2021
(86) PCT No.: PCT/JP2021/015452

§ 371 Date: Oct. 14, 2022

(30) Foreign Application Priority Data
Apr. 28, 2020 (JP) 2020-078848

(51) Int. Cl. C08G 64/04; G02B 1/04

(52) U.S. Cl. CPC C08G 64/04; G02B 1/041

(57) ABSTRACT

[Problem] An object of the present invention is to provide a thermoplastic resin having high refractive index and low Abbe number and an optical member containing the same.

[Solution] A thermoplastic resin having repeating units represented by the following formula (1):

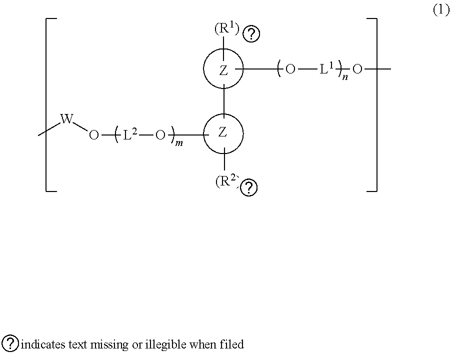

wherein Z is a polycyclic aromatic hydrocarbon having three or more benzene rings condensed, each of L¹ and L² independently represents a divalent linking group, each of R¹ and R² independently represents a hydrogen atom, a halogen atom, or a substituent having 1 to 20 carbon atoms and optionally containing an aromatic group, each of j1 and j2 independently represents an integer of 1 or more, each of m and n independently represents 0 or 1, and W is at least one selected from the group represented by the following formulae (2) and (3):

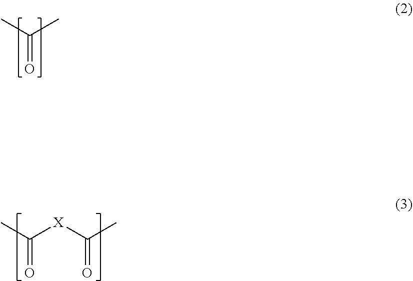

wherein X represents a divalent linking group.

### TECHNICAL FIELD

The present invention relates to a thermoplastic resin which has high refractive index, and which can achieve excellent balance between the heat resistance and moldability.

### BACKGROUND ART

In a camera, a video camera, a mobile phone with a camera, a videophone, an intercom with a camera, and the like, an imaging module is used. In recent years, the optical system used in the imaging module is particularly required to be downsized. As the optical system is downsized, chromatic aberration of the optical system causes a serious problem. It has been known that the chromatic aberration can be corrected by combining an optical lens material having dispersion increased by increasing the refractive index for optical lens and reducing the Abbe number and an optical lens material having dispersion reduced by reducing the refractive index and increasing the Abbe number.

Glass has conventionally been used as a material for optical system and can achieve various optical properties required, and further has excellent environmental resistance, but poses a problem of poor processability. A resin is, meanwhile, inexpensive as compared to the glass materials, and has excellent processability, and is being used in optical parts. Particularly, a resin having a fluorene skeleton or a binaphthalene skeleton is used for the reason that it has high refractive index, and the like. For example, PTLs 1 and 2 have a description of a high refractive index resin having a refractive index of 1.64 using 9,9-bis(4-(2-hydroxyethoxy)phenyl)fluorene. However, the refractive index of the resin is unsatisfactory, and the resin is required to be further increased in the refractive index. Further, PTL 3 has a description of a thermoplastic resin having 9,9-bis(4-(2-hydroxyethoxy)-3-phenylphenyl)fluorene.

PTL 4 has a description about a thermoplastic resin having an aromatic ring introduced into a fluorene skeleton for increasing the refractive index, and PTL 5 has a description of a thermoplastic resin having an aromatic ring introduced into a binaphthalene skeleton. However, the thermoplastic resins are required to be further increased in the refractive index due to the recent rapid technological innovations.

### CITATION LIST

### Literature

PTL 1: International Patent Application Publication No. 2007/142149
PTL 2: JP-A-7-198901
PTL 3: JP-A-2015-86265
PTL 4: International Patent Application Publication No. 2019/044214
PTL 5: International Patent Application Publication No. 2019/044875

### SUMMARY OF INVENTION

### Technical Problem

A task to be achieved by the present invention is to provide a thermoplastic resin having high refractive index and low Abbe number and an optical member containing the same.

### Solution to Problem

The present inventors have conducted extensive and intensive studies with a view toward achieving the object. As a result, it has been found that the above-mentioned problems can be solved by a thermoplastic resin containing a structure having three or more benzene rings condensed, and the present invention has been completed. Specifically, the present invention is as follows.

### «Mode 1»

A thermoplastic resin having repeating units represented by the following formula (1):

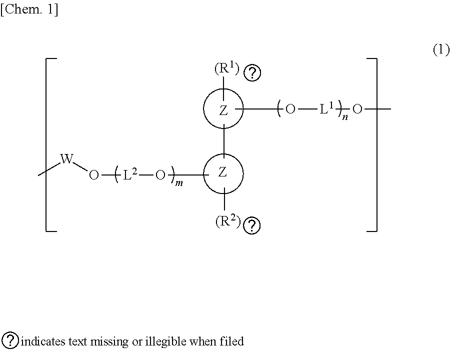

wherein Z is a polycyclic aromatic hydrocarbon having three or more benzene rings condensed, each of L¹ and L² independently represents a divalent linking group, each of R¹ and R² independently represents a hydrogen atom, a halogen atom, or a substituent having 1 to 20 carbon atoms and optionally containing an aromatic group, each of j1 and j2 independently represents an integer of 1 or more, each of m and n independently represents 0 or 1, and W is at least one selected from the group represented by the following formulae (2) and (3):

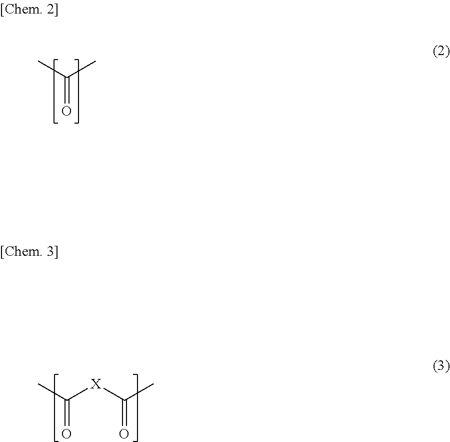

wherein X represents a divalent linking group.

### «Mode 2»

The thermoplastic resin according to Mode 1, wherein, in the formula (1), Z is a polycyclic aromatic hydrocarbon of a phenacene type.

### «Mode 3»

The thermoplastic resin according to Mode 1 or 2, wherein, in the formula (1), Z is a polycyclic aromatic hydrocarbon having three or four benzene rings condensed.

### «Mode 4»

The thermoplastic resin according to any one of Modes 1 to 3, wherein, in the formula (1), Z is phenanthrene.

### «Mode 5»

The thermoplastic resin according to any one of Modes 1 to 4, wherein the repeating units represented by the formula (1) are represented by the following formula (4):

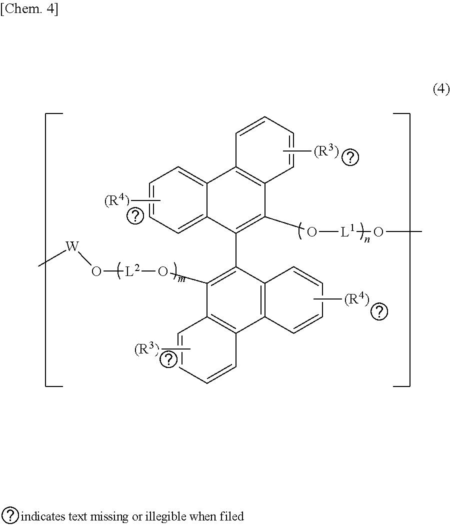

wherein each of L¹ and L² independently represents a divalent linking group, each of R³ and R⁴ independently represents a hydrogen atom, a halogen atom, or a substituent having 1 to 20 carbon atoms and optionally containing an aromatic group, each of j3 and j4 independently represents an integer of 1 or more, each of m and n independently represents 0 or 1, and W is at least one selected from the group represented by the formulae (2) and (3).

### «Mode 6»

The thermoplastic resin according to any one of Modes 1 to 4, wherein, in the formula (1), each of R¹ and R² independently represents a hydrogen atom, a methyl group, a phenyl group, or a naphthyl group.

### «Mode 7»

The thermoplastic resin according to Mode 5, wherein, in the formula (4), each of R³ and R⁴ independently represents a hydrogen atom, a methyl group, a phenyl group, or a naphthyl group.

### «Mode 8»

The thermoplastic resin according to any one of Modes 1 to 7, wherein X in the formula (3) is at least one selected from the group consisting of a phenylene group, a naphthalenediyl group, a group represented by the following formula (5), and a group represented by the following formula (6) and contained as the repeating units:

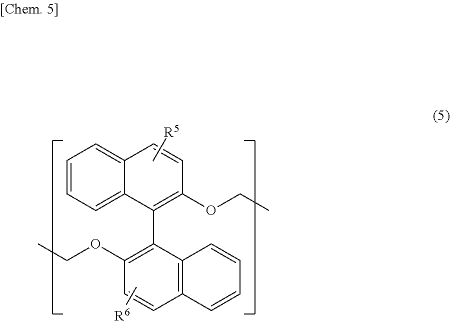

wherein each of R⁵ and R⁶ is independently a hydrogen atom, a substituent having 1 to 20 carbon atoms and optionally containing an aromatic group, or a halogen atom,

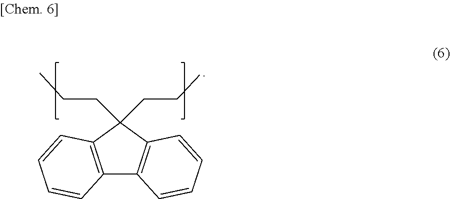

### «Mode 9»

The thermoplastic resin according to any one of Modes 1 to 8, which has at least one unit selected from the group consisting of units represented by the following formulae (7) to (10) as the repeating units:

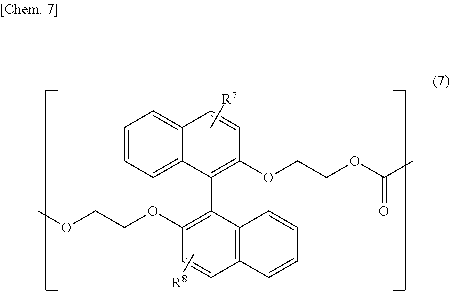

wherein each of R⁷ and R⁸ is independently a hydrogen atom, a substituent having 1 to 20 carbon atoms and optionally containing an aromatic group, or a halogen atom,

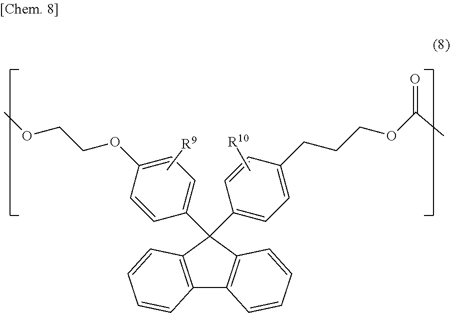

wherein each of R⁹ and R¹⁰ is independently a hydrogen atom, a substituent having 1 to 20 carbon atoms and optionally containing an aromatic group, or a halogen atom,

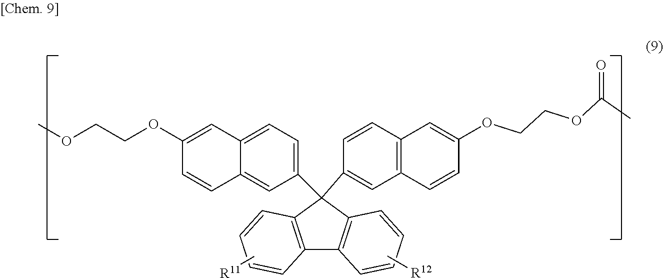

wherein each of R¹¹ and R¹² is independently a hydrogen atom, a substituent having 1 to 20 carbon atoms and optionally containing an aromatic group, or a halogen atom,

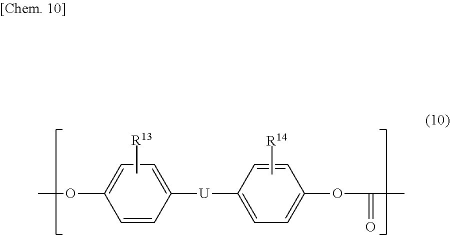

wherein each of R¹² and R¹⁴ is independently a hydrogen atom, a substituent having 1 to 20 carbon atoms and optionally containing an aromatic group, or a halogen atom, and U is a single bond or a divalent linking group.

### «Mode 10»

The thermoplastic resin according to any one of Modes 1 to 9, which has a refractive index of 1.65 to 1.80.

### «Mode 11»

The thermoplastic resin according to any one of Modes 1 to 10, which has a specific viscosity of 0.12 to 0.40.

### «Mode 12»

The thermoplastic resin according to any one of Modes 1 to 11, which has a glass transition temperature of 130 to 170° C.

### «Mode 13»

An optical member comprising the thermoplastic resin according to any one of Modes 1 to 12.

### «Mode 14»

The optical member according to Mode 13, which is an optical lens.

### Advantageous Effects of Invention

The thermoplastic resin of the present invention has high refractive index and low Abbe number, and therefore can be used in optical members, such as an optical lens, a prism, an optical disc, a transparent conductive substrate, an optical card, a sheet, a film, an optical fiber, an optical film, an optical filter, and a hard coat film, and particularly, is extremely useful as an optical lens for use in a mobile phone, a smartphone, a tablet terminal, a personal computer, a digital camera, a video camera, a camera for car (or a dashcam), or a surveillance camera, and thus the thermoplastic resin of the invention is of extremely great commercial significance.

### BRIEF DESCRIPTION OF DRAWING

FIG. 1 Transmission spectra of 0.1% by mass dichloromethane solutions of the thermoplastic resins in Example 1 and Comparative Example 2.

### DESCRIPTION OF EMBODIMENTS

The present invention will be described in detail.

### <Thermoplastic Resin>

A thermoplastic resin having repeating units represented by the following formula (1):

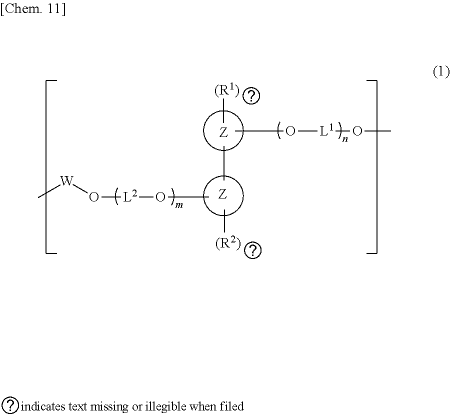

wherein Z is a polycyclic aromatic hydrocarbon having three or more benzene rings condensed, each of L¹ and L² independently represents a divalent linking group, each of R¹ and R² independently represents a hydrogen atom, a halogen atom, or a substituent having 1 to 20 carbon atoms and optionally containing an aromatic group, each of j1 and j2 independently represents an integer of 1 or more, each of m and n independently represents 0 or 1, and W is at least one selected from the group represented by the following formulae (2) and (3):

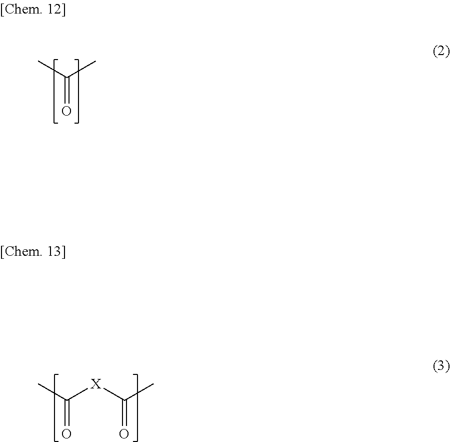

wherein X represents a divalent linking group.

In the formula (1) above, Z is a polycyclic aromatic hydrocarbon having three or more benzene rings condensed, preferably a polycyclic aromatic hydrocarbon having three or four benzene rings condensed, more preferably a polycyclic aromatic hydrocarbon having three benzene rings condensed.

Further, in the formula (1), the polycyclic aromatic hydrocarbon for Z preferably has a structure in which the condensed benzene rings are of an acene type or a phenacene type, more preferably a structure in which the condensed benzene rings are of a phenacene type.

In the formula (1), Z is preferably phenanthrene, anthracene, phenalene, chrysene, tetracene, or pyrene, more preferably phenanthrene, anthracene, chrysene, or tetracene, and phenanthrene or chrysene is further preferred from the viewpoint of the stability due to a change of the frontier orbital when the number of condensed rings is increased, and phenanthrene is especially preferred from the viewpoint of the absorption wavelength.

In the formula (1), each of R¹ and R² independently represents a hydrogen atom, a halogen atom, or a substituent having 1 to 20 carbon atoms and optionally containing an aromatic group, preferably a hydrogen atom, a methyl group, a phenyl group, a naphthyl group, a thienyl group, or a benzothienyl group, more preferably a hydrogen atom, a methyl group, a phenyl group, or a naphthyl group, further preferably a hydrogen atom or a methyl group, especially preferably a hydrogen atom.

The halogen atom is preferably a fluorine atom, a chlorine atom, a bromine atom, or the like.

The substituent having 1 to 12 carbon atoms and optionally containing an aromatic group is preferably a phenyl group, a naphthyl group, a thienyl group, a benzothienyl group, or the like.

As specific examples of the naphthyl group, preferred are a l-naphthyl group, a 2-naphthyl group, and the like.

As specific examples of the thienyl group, preferred are a 2-thienyl group, a 3-thienyl group, and the like.

As specific examples of the benzothienyl group, preferred are a 2-benzo[b]thienyl group, a 3-benzo[b]thienyl group, and the like.

In the formula (1), each of L¹ and L² independently represents a divalent linking group, preferably an alkylene group having 1 to 12 carbon atoms, more preferably an alkylene group having 1 to 4 carbon atoms, further preferably an ethylene group. By controlling the length of the linking group for L¹ and 1,², the glass transition temperature (mg) of the resin can be controlled.

In the formula (1), W is at least one selected from the group represented by the formulae (2) and (3) above. When W is the formula (2), the formula (1) is a carbonate unit, and, when W is the formula (3), the formula (1) is an ester unit.

The formula (1) above can be obtained from a dihydroxy compound and a carbonate precursor material, such as a carbonic ester, or a dihydroxy compound and a dicarboxylic acid or an ester-forming derivative thereof.

In the formula (1), each of m and n is independently 0 or I, more preferably 1.

In the formula (1), each of j1 and j2 is independently an integer of 1 or more, preferably an integer of 1 to 4, more preferably 1.

Further, the repeating units represented by the formula (1) are preferably repeating units represented by the following formula (4):

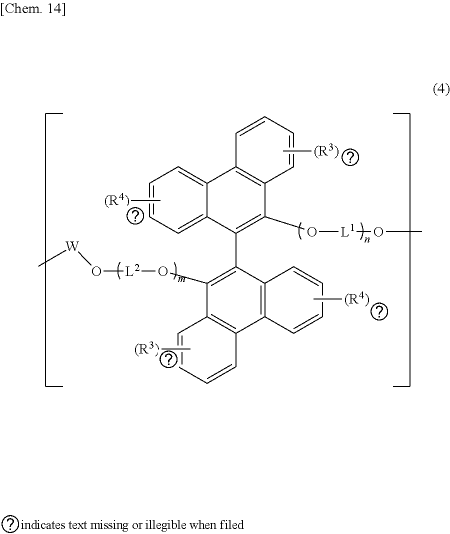

wherein each of R³ and R⁴ independently represents a hydrogen atom, a halogen atom, or a substituent having 1 to 20 carbon atoms and optionally containing an aromatic group, each of j3 and j4 independently represents an integer of 0 or more, and L¹, L², m, n, and W are as defined above in the formula (1).

In the formula (4) above, each of R³ and R⁴ independently represents a hydrogen atom, a halogen atom, or a substituent having 1 to 20 carbon atoms and optionally containing an aromatic group, preferably a hydrogen atom, a methyl group, a phenyl group, a naphthyl group, a thienyl group, or a benzothienyl group, more preferably a hydrogen atom, a methyl group, a phenyl group, or a naphthyl group, further preferably a hydrogen atom or a methyl group, especially preferably a hydrogen atom.

In the formula (4), j3 and j4 are an integer of 1 or more, preferably an integer of 1 to 4, more preferably 1.

In the formula (3) above, X represents a divalent linking group, preferably a substituent having 1 to 30 carbon atoms and optionally containing an aromatic group, more preferably a phenylene group, a naphthalenediyl group, or a group represented by the following formula (5) or (6):

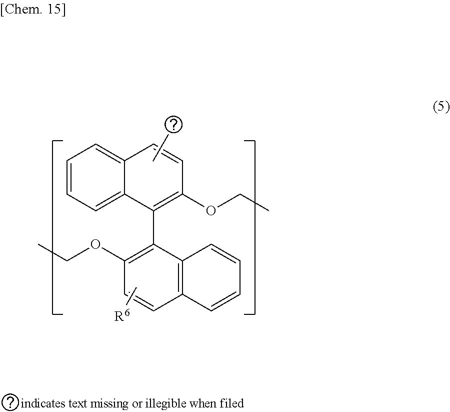

wherein each of R⁵ and R⁶ independently represents a hydrogen atom, a substituent having 1 to 20 carbon atoms and optionally containing an aromatic group, or a halogen atom,

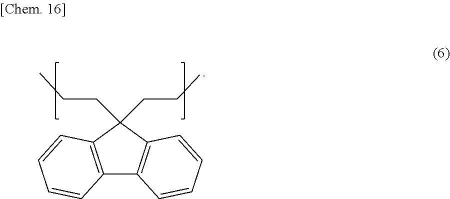

In the formula (5) above, each of R⁵ and R⁶ independently represents a hydrogen atom, a halogen atom, or a substituent having 1 to 20 carbon atoms and optionally containing an aromatic group, preferably a hydrogen atom, a methyl group, a phenyl group, a naphthyl group, a thienyl group, or a benzothienyl group, more preferably a hydrogen atom, a methyl group, a phenyl group, or a naphthyl group, further preferably a hydrogen atom or a methyl group, especially preferably a hydrogen atom.

The reason why the thermoplastic resin can have high refractive index and low Abbe number which are the effects of the present invention is considered as follows.

In PTLs 4 and 5, the refractive index is improved by introducing an aromatic group through a single bond. From the equation for relationship between the molecular structure and the refractive index, which is known as the Lorentz-Lorenz equation, it has been known that the refractive index of a substance is increased by increasing the polarizability of the molecules, and, at the same time, the Abbe number is reduced.

In the present invention, a resin having high refractive index and low Abbe number, which has not been achieved by the conventional techniques, can be obtained. It is considered that, by virtue of having a structure having three or more rings condensed, the polarizability can be improved, as compared to that in the case of introducing an aromatic group through a single bond, and therefore high refractive index can be achieved.

Further, it is considered that the introduction of an aromatic ring to form a phenacene structure can solve a problem of a trade-off between the refractive index improvement effect and an increase of the absorption wavelength, which is the problem of the conventional techniques. For example, when a comparison is made between the case where a phenyl group is introduced into a binaphthalene structure at the 6,6-position and the case where biphenanthrene is obtained from a binaphthalene structure, the number of aromatic rings is increased only by two in both cases, but it is found that, in the case of biphenanthrene, the refractive index is higher and an increase of the absorption wavelength is suppressed. As apparent from the above, the phenacene structure is considered useful as a structure for materials in the optical application.

The repeating units represented by the formula (1) may be contained in an amount of 5 mol % or more, 10 mol % or more, 15 mol % or more, 20 mol % or more, 25 mol % or more, or 30 mol % or more, and in an amount of 100 mol % or less, 90 mol % or less, 80 mol % or less, 70 mol % or less, 60 mol % or less, or 50 mol % or less. The resin of the invention preferably has the repeating units represented by the formula (1) in an amount of 10 mol % or more and 100 mol % or less, more preferably 20 mol % or more and 100 mol % or less, further preferably 20 mol % or more and 80 mol % or less, especially preferably 20 mol % or more and 70 mol % or less. When the amount of the repeating units represented by the formula (1) is in the above range, excellent balance between the refractive index, heat resistance, and moldability is advantageously achieved.

The thermoplastic resin of the invention can have at least one unit selected from the group consisting of units represented by the formulae (7) to (10) above as the repeating units.

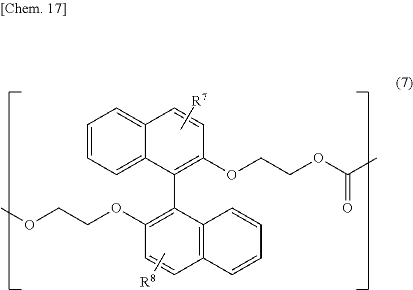

Wherein R⁷ and R⁸ are as defined above for R⁵ and R⁶ in the formula (5).

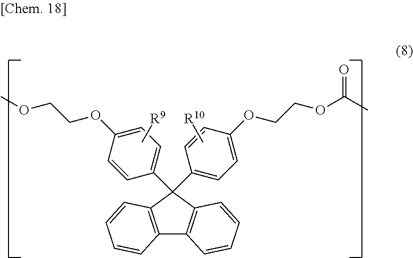

Wherein R⁹ and R¹⁰ are as defined above for R⁵ and R⁶ in the formula (5).

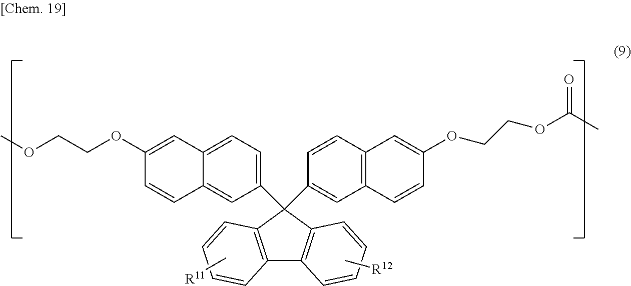

Wherein R¹¹ and R¹² are as defined above for R⁵ and R⁶ in the formula (5).

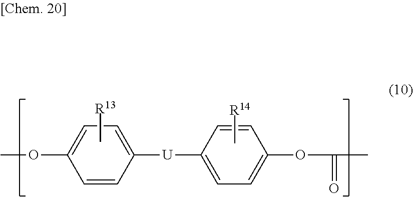

Wherein R¹³ and R¹⁴ are as defined above for R⁵ and R⁶ in the formula (5), and U represents a single bond or a divalent linking group.

The molar ratio of the repeating units represented by the formula (1) and repeating units selected from the group consisting of the units represented by the formulae (7) to (10) above is preferably 95:5 to 5:95, more preferably 80:20 to 20:80, further preferably 70:30 to 30:70. When the molar ratio of the repeating units represented by the formula (1) and at least one repeating unit selected from the group consisting of the units represented by the formulae (7) to (10) is in the above range, not only high refractive index but also excellent balance between the high refractive index and moldability can be advantageously achieved.

### <Physical Properties of the Thermoplastic Resin>

The thermoplastic resin of the invention preferably has a specific viscosity of 0.12 to 0.40, more preferably 0.14 to 0.35, further preferably 0.16 to 0.30. When the specific viscosity of the thermoplastic resin is in the above range, excellent balance between the moldability and mechanical strength is advantageously achieved.

A measurement method for a specific viscosity is as follows. 0.7 g of the thermoplastic resin is dissolved in 100 ml of methylene chloride, and a specific viscosity (ηSP) of the resultant solution at 20° C. is measured by an Ostwald viscometer and determined by calculation from the following formula.

Specific viscosity (ηSP)=(t−t₀)/t₀

[wherein t₀ is the duration (seconds) of falling of methylene chloride, and t is the duration (seconds) of falling of a sample solution.]

The thermoplastic resin of the invention may have a refractive index, as measured at a temperature of 20° C. and at a wavelength of 587.56 nm, of 1.650 or more, 1.660 or more, 1.670 or more, 1.680 or more, 1.690 or more, or 1.700 or more, and of 1.800 or less, 1.790 or less, 1.780 or less, 1.770 or less, 1.760 or less, or 1.750 or less. The refractive index of the thermoplastic resin is preferably 1.650 to 1.800, more preferably 1.670 to 1.800, further preferably 1.680 to 1.800. When the refractive index of the thermoplastic resin is the lower limit or more, an optical lens obtained from the thermoplastic resin can be reduced in spherical aberration, and further the optical lens can be reduced in focal length.

The thermoplastic resin of the invention has high refractive index, but it is preferred that the thermoplastic resin further has low Abbe number.

The thermoplastic resin of the invention may have an Abbe number of 5 or more, 7 or more, 9 or more, 10 or more, 12 or more, or 14 or more, and of 24 or less, 23 or less, 22 or less, 21 or less, 20 or less, 19 or less, or 18 or less. The Abbe number (νd) of the thermoplastic resin is preferably 5 to 22, more preferably 7 to 22, further preferably 10 to 21.

The Abbe number is determined by making a calculation from refractive indexes at a wavelength of 486.13 nm, 587.56 nm, and 656.27 nm and at a temperature of 20° C. using the following formula:

νd=(nd−1)/(nF−nC)
nd: means a refractive index at a wavelength of 587.56 nm,
nF: means a refractive index at a wavelength of 486.13 nm,
nC: means a refractive index at a wavelength of 656.27 nm.

The thermoplastic resin of the invention may have a glass transition temperature (Tg) of 130° C. or higher, 135° C. or higher, 140° C. or higher, 145° C. or higher, or 150° C. or higher, and of 180° C. or lower, 175° C. or lower, 170° C. or lower, 165° C. or lower, or 160° C. or lower. The glass transition temperature of the thermoplastic resin is preferably 130 to 180° C., more preferably 140 to 175° C., further preferably 140 to 170° C. When the glass transition temperature of the thermoplastic resin is in the above range, excellent balance between the heat resistance and moldability is advantageously achieved.

The thermoplastic resin of the invention preferably has an orientation birefringence absolute value (|Δn|) of 10.0×10⁻³ or less, further preferably 5.0×10⁻³ or less, further preferably 3.0×10 or less. When the |Δn| of the thermoplastic resin is in the above range, an optical lens obtained from the thermoplastic resin advantageously has optical strain reduced.

The Δn is determined by obtaining a film having a thickness of 100 μm from the thermoplastic resin of the invention and two-fold stretching the film at a temperature of Tg+10° C., and measuring a phase difference at a wavelength of 589 nm of the resultant film and making a calculation from the following formula.

|Δn|=|Re/d|

Δn: Orientation birefringence

Re: Phase difference (nm)

d: Thickness (nm)

The thermoplastic resin of the invention preferably has a water absorption of 0.25% by mass or less after immersed in water at 23° C. for 24 hours, more preferably 0.20% by weight or less. When the water absorption of the thermoplastic resin is in the above range, a change of the optical properties due to water absorption is advantageously small.

The thermoplastic resin of the invention preferably has a spectral transmittance at 360 nm of 40% or more, more preferably 50% or more, further preferably 60% or more, especially preferably 70% or more. When the spectral transmittance of the thermoplastic resin is in the above range, the thermoplastic resin can advantageously transmit a visible light.

### <Raw Materials for the Thermoplastic Resin>

### (Diol Component for the Formula (1))

The diol component as a raw material for the formula (1) is mainly a diol component represented by the formula (a) below, and the diol components may be used individually or in combination.

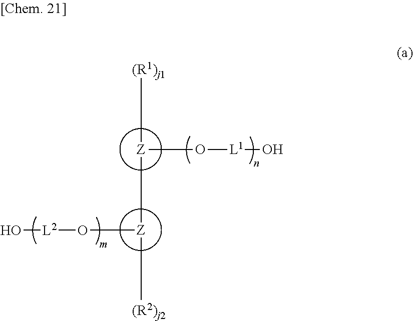

In the formula (a) above, Z, R¹, R², L¹, L², j1, j2, m, and n are the same as those in the formula (1) above.

Representative specific examples of the diol component represented by the formula (a) above are shown below, but the raw material used for the formula (1) is not limited by these examples.

With respect to the diol compound represented by the formula (1), as specific examples, there can be mentioned bianthracenols, biphenanthrenols, biphenalenols, binaphthacenols, bichrysenols, and bipyrenols. Specifically, as preferred examples, there can be mentioned compounds represented by the formula (a-1) below, such as 2,2′-dihydroxy-1,1′-bianthracene, 10,10′-dihydroxy-9,9′-bianthracene, 2,2′-dihydroxy-1,1′-biphenanthrene, 3,3′-dihydroxy-4,4′-biphenanthrene, 10,10′-dihydroxy-9,9′-biphenanthrene, 2,2′-dihydroxy-1,1′-biphenalene, 3,3′-dihydroxy-2,2′-binaphthacene, 12,12′-dihydroxy-5,5′-binaphthacene, 3,3′-dihydroxy-4,4′-bichrysene, 5,5′-dihydroxy-6,6′-bichrysene, 2,2′-dihydroxy-1,1-bipyrene, and 7,7′-dihydroxy-2,2′-bipyrene, and compounds represented by the formula (a-2) below, such as 2,2′-bis(2-hydroxyethoxy)-1,1′-bianthracene, 10,10′-bis(2-hydroxyethoxy)-9,9′-bianthracene, 2,2′-bis(2-hydroxyethoxy)-1,1′-biphenanthrene, 3,3′-bis(2-hydroxyethoxy)-4,4′-biphenanthrene, 10,10′-bis(2-hydroxyethoxy)-9,9′-biphenanthrene, 2,2′-bis(2-hydroxyethoxy)-1,1′-biphenalene, 3,3′-bis(2-hydroxyethoxy)-2,2′-binaphthacene, 12,12′-bis(2-hydroxyethoxy)-5,5′-binaphthacene, 3,3′-bis(2-hydroxyethoxy)-4,4′-bichrysene, 5,5′-bis(2-hydroxyethoxy)-6,6′-bichrysene, 2,2′-bis(2-hydroxyethoxy)-1,1-bipyrene, and 7,7′-bis(2-hydroxyethoxy)-2,2′-bipyrene, and more preferred are 2,2′-dihydroxy-1,1′-biphenanthrene, 3,3′-dihydroxy-4,4′-biphenanthrene, 10,10′-dihydroxy-9,9′-biphenanthrene, 3,3′-dihydroxy-4,4′-bichrysene, 5,5′-dihydroxy-6,6′-bichrysene, 2,2′-bis(2-hydroxyethoxy)-1,1′-biphenanthrene, 3,3′-bis(2-hydroxyethoxy)-4,4′-biphenanthrene, 10,10′-bis(2-hydroxyethoxy)-9,9′-biphenanthrene, 3,3′-bis(2-hydroxyethoxy)-4,4′-bichrysene, and 5,5′-bis(2-hydroxyethoxy)-6,6′-bichrysene, further preferred are 2,2′-dihydroxy-1,1′-biphenanthrene, 3,3′-dihydroxy-4,4′-biphenanthrene, 10,10′-dihydroxy-9,9′-biphenanthrene, 2,2′-bis(2-hydroxyethoxy)-1,1′-biphenanthrene, 3,3′-bis(2-hydroxyethoxy)-4,4′-biphenanthrene, and 10,10′-bis(2-hydroxyethoxy)-9,9′-biphenanthrene, and especially preferred are 10,10′-dihydroxy-9,9′-biphenanthrene and 10,10′-bis(2-hydroxyethoxy)-9,9′-biphenanthrene.

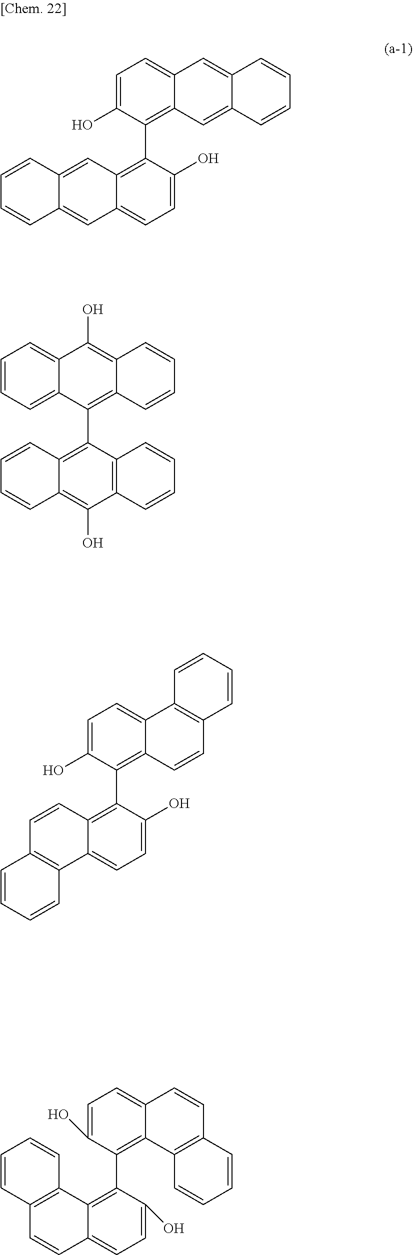 [SMILES: Oc1ccc2cc3ccccc3cc2c1-c1c(O)ccc2cc3ccccc3cc12 ; Oc1c2ccccc2c(-c2c3ccccc3c(O)c3ccccc23)c2ccccc12 ; Oc1ccc2c(ccc3ccccc32)c1-c1c(O)ccc2c1ccc1ccccc12 ; Oc1ccc2ccc3ccccc3c2c1-c1c(O)ccc2ccc3ccccc3c12]

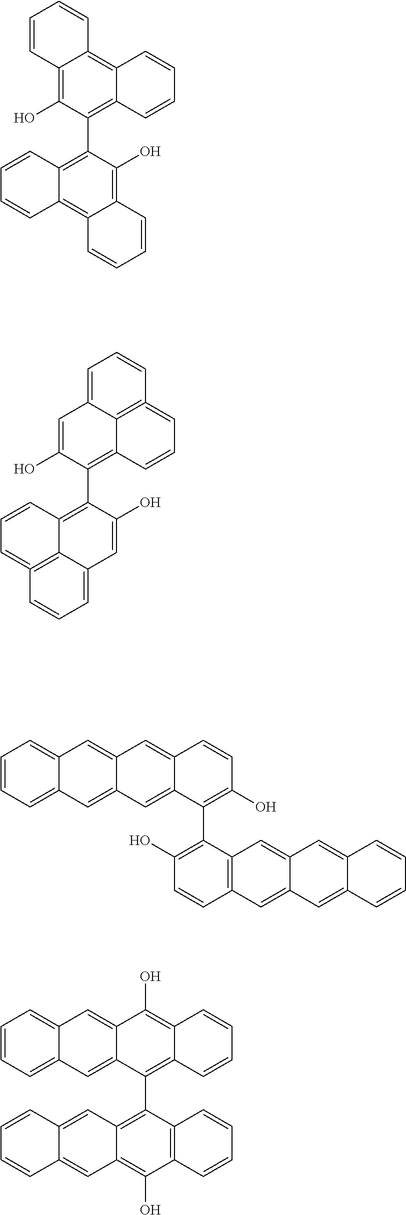

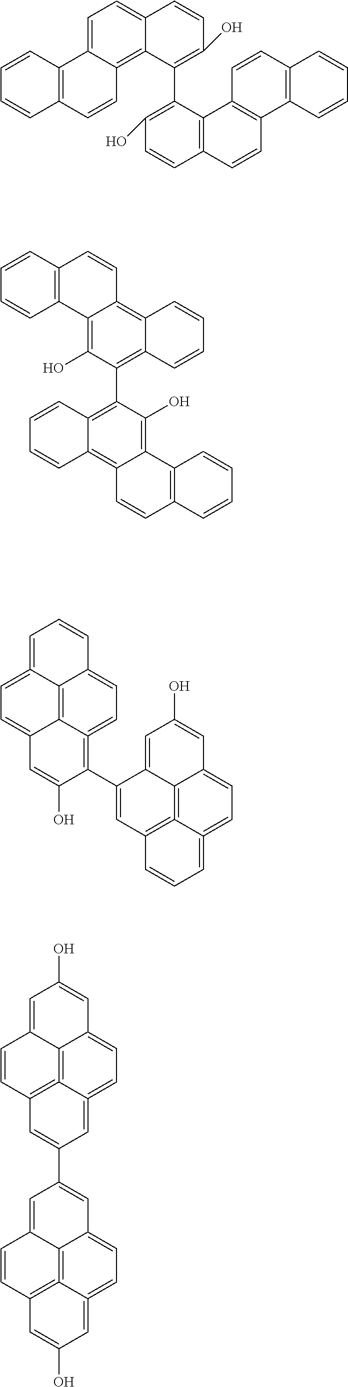

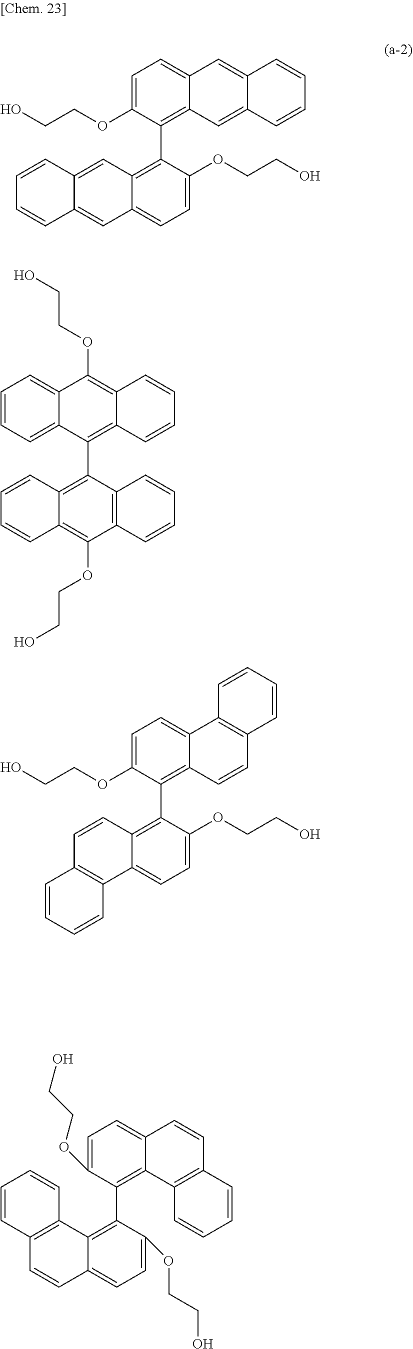 [SMILES: OCCOc1ccc2cc3ccccc3cc2c1-c1c(OCCO)ccc2cc3ccccc3cc12 ; OCCOc1c2ccccc2c(-c2c3ccccc3c(OCCO)c3ccccc23)c2ccccc12 ; OCCOc1ccc2c(ccc3ccccc32)c1-c1c(OCCO)ccc2c1ccc1ccccc12 ; OCCOc1ccc2ccc3ccccc3c2c1-c1c(OCCO)ccc2ccc3ccccc3c12]

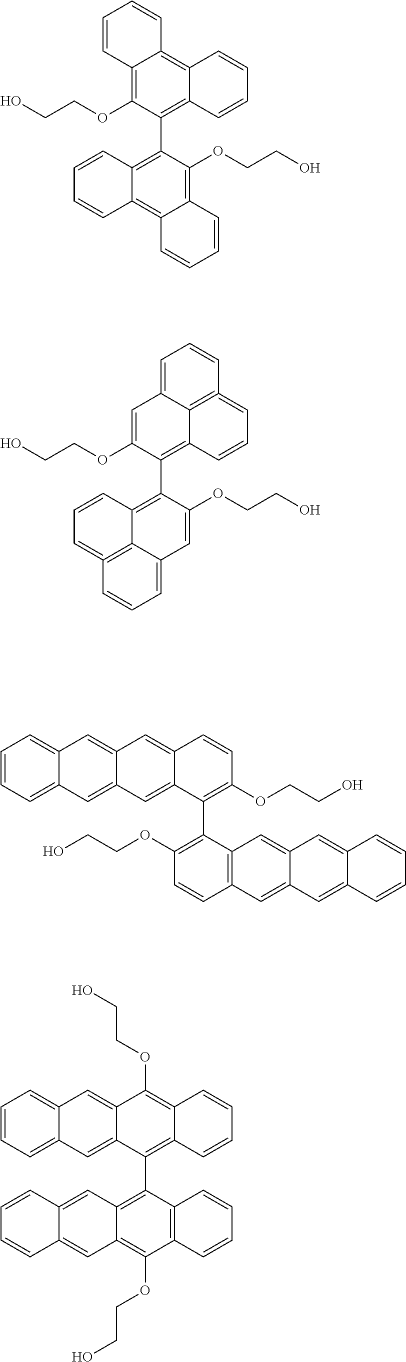

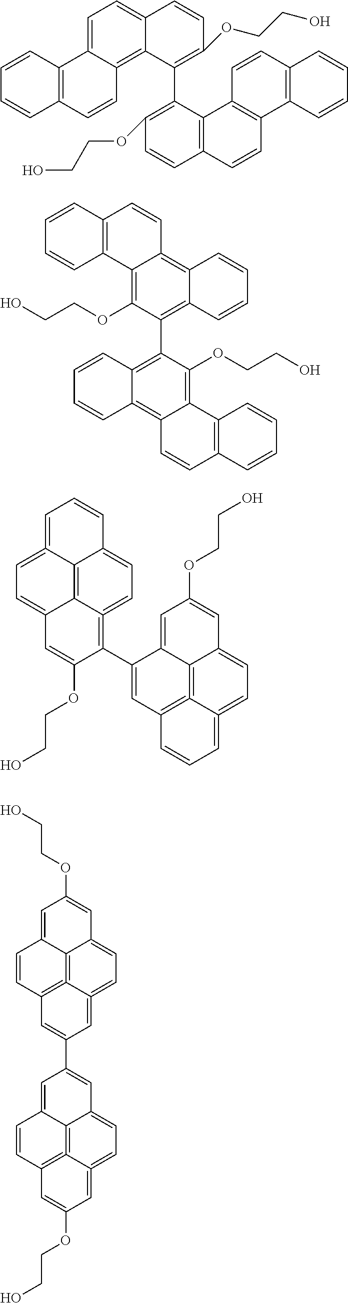

### (Carbonate Component for the Formula (1))

With respect to the carbonate component used for the units represented by the formula (1) of the thermoplastic resin of the invention, there can be mentioned phosgene and a carbonate ester. Examples of carbonate esters include esters of an aryl group or aralkyl group having 6 to 10 carbon atoms, or an alkyl group having 1 to 4 carbon atoms, each optionally being substituted. Specific examples include diaryl carbonates, such as diphenyl carbonate, ditolyl carbonate, bis(chlorophenyl) carbonate, bis(m-cresyl) carbonate, and dinaphthyl carbonate; dialkyl carbonates, such as dimethyl carbonate, diethyl carbonate, dibutyl carbonate, and dicyclohexyl carbonate; alkylaryl carbonates, such as ethylphenyl carbonate and cyclohexylphenyl carbonate; and dialkenyl carbonates, such as divinyl carbonate, diisopropenyl carbonate, and dipropenyl carbonate, and, of these, diaryl carbonates are preferred, and diphenyl carbonate is more preferred.

### (Dicarboxylic Acid Component for the Formula (1))

With respect to the dicarboxylic acid component used for the units represented by the formula (1) of the thermoplastic resin of the invention, mainly, a dicarboxylic acid represented by the formula (b) below or an ester-forming derivative thereof is preferably used.

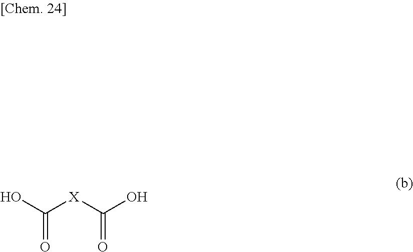

In the formula (b) above, X represents a divalent linking group, and is similar to that described above for the formula (3).

Representative specific examples of the dicarboxylic acid represented by the formula (b) above or ester-forming derivative thereof are shown below, but the raw material used for the formula (b) in the invention is not limited by these examples.

With respect to the dicarboxylic acid component used for the thermoplastic resin of the invention, examples include 2,2′-bis(carboxymethoxy)-1,1′-binaphthyl, 6,6′-diphenyl-2,2′-bis(carboxymethoxy)-1,1′-binaphthyl, and 6,6′-dibromo-2,2′-bis(carboxymethoxy)-1,1′-binaphthyl, which are a raw material for the formula (5); 9,9-bis(2-carboxyethyl)fluorene which is a raw material for the formula (6); aliphatic dicarboxylic acid components, such as malonic acid, succinic acid, glutaric acid, adipic acid, pimelic acid, suberic acid, azelaic acid, methylmalonic acid, and ethylmalonic acid; monocyclic aromatic dicarboxylic acid components, such as phthalic acid, isophthalic acid, and terephthalic acid; polycyclic aromatic dicarboxylic acid components, such as 2,6-naphthalenedicarboxylic acid, 2,7-naphthalenedicarboxylic acid, 2,3-naphthalenedicarboxylic acid, 1,4-naphthalenedicarboxylic acid, 1,8-naphthalenedicarboxylic acid, anthracenedicarboxylic acid, phenanthrenedicarboxylic acid, 9,9-bis(carboxymethyl)fluorene, 9,9-bis(1-carboxyethyl)fluorene, 9,9-bis(1-carboxypropyl)fluorene, 9,9-bis(2-carboxypropyl)fluorene, 9,9-bis(2-carboxy-1-methylethyl)fluorene, 9,9-bis(2-carboxy-1-methylpropyl)fluorene, 9,9-bis(2-carboxybutyl)fluorene, 9,9-bis(2-carboxy-1-methylbutyl)fluorene, 9,9-bis(5-carboxypentyl)fluorene, and 9,9-bis(carboxycyclohexyl)fluorene; biphenyldicarboxylic acid components, such as 2,2′-biphenyldicarboxylic acid; and alicyclic dicarboxylic acid components, such as 1,4-cyclohexanedicarboxylic acid and 2,6-decalindicarboxylic acid, and preferred are isophthalic acid, terephthalic acid, 2,6-naphthalenedicarboxylic acid, 2,2′-bis(carboxymethoxy)-1,1′-binaphthyl, and 9,9-bis(2-carboxyethyl)fluorene, and more preferred are 2,6-naphthalenedicarboxylic acid, 2,2′-bis(carboxymethoxy)-1,1′-binaphthyl, and 9,9-bis(2-carboxyethyl)fluorene. These may be used individually or in combination. Further, as an ester-forming derivative, acid chloride or an ester, such as a methyl ester, an ethyl ester, or a phenyl ester, may be used.

### (Components for the Formulae (7) to (10))

The thermoplastic resin of the invention may further have the repeating units of the formulae (7) to (10) above, and dihydroxy compound components which are raw materials for the formulae (7) to (10) are shown below. These may be used individually or in combination.

With respect to the dihydroxy compound component which is a raw material for the formula (7) in the invention, examples include 2,2′-bis(2-hydroxyethoxy)-1,1′-binaphthyl, 2,2′-bis(2-hydroxyethoxy)-3,3′-diphenyl-1,1′-binaphthyl, 2,2′-bis(2-hydroxyethoxy)-6,6′-diphenyl-1,1′-binaphthyl, 2,2′-bis(2-hydroxyethoxy)-7,7′-diphenyl-1,1′-binaphthyl, 2,2′-bis(2-hydroxyethoxy)-3,3′-dimethyl-1,1′-binaphthyl, 2,2′-bis(2-hydroxyethoxy)-6,6′-dimethyl-1,1′-binaphthyl, and 2,2′-bis(2-hydroxyethoxy)-7,7′-dimethyl-1,1′-binaphthyl.

With respect to the dihydroxy compound component which is a raw material for the formula (8) in the invention, examples include 9,9-bis(4-(2-hydroxyethoxy)fluorene, 9,9-bis(4-(2-hydroxyethoxy)phenyl)fluorene, 9,9-bis(4-(2-hydroxyethoxy)-3-methylphenyl)fluorene, 9,9-bis(4-(2-hydroxyethoxy)-3-cyclohexylphenyl)fluorene, and 9,9-bis(4-(2-hydroxyethoxy)-3-phenylphenyl)fluorene, and especially preferred are 9,9-bis(4-(2-hydroxyethoxy)phenyl)fluorene and 9,9-bis(4-(2-hydroxyethoxy)-3-phenylphenyl)fluorene. These may be used individually or in combination.

With respect to the dihydroxy compound component which is a raw material for the formula (9) in the invention, examples include 9,9-bis(6-(2-hydroxyethoxy)-2-naphthyl)fluorene and 9,9-bis(6-(2-hydroxyethoxy)-2-naphthyl)-2,7-diphenylfluorene.

With respect to the dihydroxy compound component which is a raw material for the formula (10) in the invention, examples include 2,2-bis(4-hydroxyphenyl)propane, 2,2-bis(3-methyl-4-hydroxyphenyl)propane, 1,1-bis(4-hydroxyphenyl)-1-phenylethane, 1,3-bis(2-(4-hydroxyphenyl)-2-propyl)benzene, 1,1-bis(4-hydroxyphenyl)-3,3,5-trimethylcyclohexane, 1,1-bis(4-hydroxyphenyl)cyclohexane, bis(4-hydroxyphenyl)diphenylmethane, 1,1-bis(4-hydroxyphenyl)decane, bis(4-hydroxyphenyl) sulfide, bis(4-hydroxy-3-methylphenyl) sulfide, biphenol, 9,9-bis(4-hydroxyphenyl)fluorene, 9,9-bis(4-hydroxy methylphenyl)fluorene, 9,9-bis(4-hydroxy cyclohexylphenyl)fluorene, 9,9-bis(4-hydroxy phenylphenyl)fluorene, bis(4-hydroxyphenyl) sulfone, and 10,10-bis(4-hydroxyphenyl)anthrone, and especially preferred are 2,2-bis(4-hydroxyphenyl)propane and bis(4-hydroxyphenyl) sulfide. These may be used individually or in combination.

(Copolymerized Component Other than the Formulae (1) (10))

In the thermoplastic resin of the invention, an additional dihydroxy compound component may be copolymerized in such an amount that the properties of the present invention are not sacrificed. The amount of the additional dihydroxy compound component is preferably less than 30 mol %, based on the total mole of the repeating units.

With respect to the additional dihydroxy compound component used in the thermoplastic resin of the invention, examples include ethylene glycol, propanediol, butanediol, pentanediol, hexanediol, heptanediol, octanediol, nonanediol, tricyclo[5.2.1.0^{2,6}]decanedimethanol, cyclohexane-1,4-dimethanol, decalin-2,6-dimethanol, norbornanedimethanol, pentacyclopentadecanedimethanol, cyclopentane-1,3-dimethanol, spiroglycol, isosorbide, isomannide, isoidide, hydroquinone, resorcinol, bis(4-(2-hydroxyethoxy)phenyl) sulfone, 1,1′-bi-2-naphthol, dihydroxynaphthalene, and bis(2-hydroxyethoxy)naphthalene, and these may be used individually or in combination.

The thermoplastic resin of the invention is produced by, for example, a method in which phosgene or a carbonate precursor material, such as a carbonic diester, is reacted with a dihydroxy compound component, a method in which a dicarboxylic acid or an ester-forming derivative thereof is reacted with a dial component, or the like. Specific examples of the methods are shown below.

### <Production Method>

### (Method for Producing a Polycarbonate Resin)

When the thermoplastic resin of the invention is a polycarbonate resin, the resin is obtained by a known reaction method in which, for example, a dihydroxy compound component and a carbonate precursor material are subjected to reaction by an interfacial polymerization method or a melt polymerization method. When producing a polycarbonate resin, if necessary, a catalyst, a terminator, an antioxidant, or the like may be used.

### (Method for Producing a Polyester Resin)

When the thermoplastic resin of the invention is a polyester resin, the resin is obtained by a known reaction method in which, for example, a dihydroxy compound component and a dicarboxylic acid or an ester-forming derivative thereof are subjected to esterification reaction or transesterification reaction, and the obtained reaction product is subjected to polycondensation reaction, obtaining a high molecular-weight product having a desired molecular weight.

### (Method for Producing a Polyester Carbonate Resin)

When the thermoplastic resin of the invention is a polyester carbonate resin, the resin can be produced by subjecting a dihydroxy compound component and a dicarboxylic acid or an ester-forming derivative thereof and phosgene or a carbonate precursor material, such as a carbonate ester, to reaction. As a polymerization method, the same method as used for the polycarbonate resin or polyester resin can be used.

### <Optical Member>

The optical member of the invention comprises the above-described thermoplastic resin. With respect to the optical member, there is no particular limitation as long as it corresponds to an optical application in which the thermoplastic resin is advantageously used, but examples of optical members include an optical lens, an optical disc, a transparent conductive substrate, an optical card, a sheet, a film, an optical fiber, a lens, a prism, an optical film, a substrate, an optical filter, and a hard coat film.

Further, the optical member of the invention may be formed from a resin composition containing the above-mentioned thermoplastic resin, and, if necessary, an additive, such as a heat stabilizer, a plasticizer, a light stabilizer, a polymerization metal deactivator, a flame retardant, a lubricant, an antistatic agent, a surfactant, an anti-fungus agent, an ultraviolet light absorber, a release agent, or an antioxidant, can be incorporated into the resin composition.

Examples of antioxidants include triethylene glycol-bis[3-(3-tert-butyl-5-methyl-4-hydroxyphenyl)propionate], 1,6-hexanediol-bis[3-(3,5-di-tert-butyl-4-hydroxyphenyl)propionate], pentaerythritol-tetrakis[3-(3,5-di-tert-butyl-4-hydroxyphenyl)propionate], octadecyl-3-(3,5-di-tert-butyl-4-hydroxyphenyl)propionate, 1,3,5-trimethyl-2,4,6-tris(3,5-di-tert-butyl-4-hydroxybenzyl)benzene, N,N-hexamethylenebis(3,3-di-tert-butyl-4-hydroxy-hydrocinnamamide), 3,5-di-tert-butyl hydroxy-benzylphosphonate-diethyl ester, tris(3,5-di-tert-butyl-4-hydroxybenzyl) isocyanurate, and 3,9-bis{1,1-dimethyl-2-[β-(3-tert-butyl-4-hydroxy-5-methylphenyl)propionyloxy]ethyl}-2,4,8,10-tetraoxaspiro(5,5)undecane. The amount of the antioxidant incorporated, relative to 100 parts by mass of the thermoplastic resin composition, is preferably 0.50 part by mass or less, more preferably 0.05 to 0.40 part by mass, further preferably 0.05 to 0.20 part by mass or 0.10 to 0.40 part by mass, especially preferably 0.20 to 0.40 part by mass.

### <Optical Lens>

With respect to the optical member of the present invention, particularly, there can be mentioned an optical lens. As examples of such optical lenses, there can be mentioned optical lenses for a mobile phone, a smartphone, a tablet terminal, a personal computer, a digital camera, a video camera, a camera for car (or a dashcam), a surveillance camera, and the like.

The optical lens of the invention can be molded or processed by an arbitrary method, such as injection molding, compression molding, injection compression molding, melt extrusion molding, or casting, but injection molding is especially preferred.

With respect to the molding conditions for injection molding, there is no particular limitation, but the cylinder temperature of a molding machine is preferably 180 to 320° C., more preferably 220 to 300° C., especially preferably 240 to 280° C. Further, the mold temperature is preferably 70 to 130° C., more preferably 80 to 125° C., especially preferably 90 to 120° C. The injection pressure is preferably 5 to 170 MPa, more preferably 50 to 160 MPa, especially preferably 100 to 150 MPa.

The present invention will be described in more detail with reference to the following Examples, which should not be construed as limiting the scope of the invention.

### EXAMPLES

### Production Examples

### Example 1

9.50 Parts by mass (20 parts by mol) of 10,10′-bis(2-hydroxyethoxy)-9,9′-biphenanthrene (hereinafter, frequently referred to simply as “BHEBPhe”), 35.08 parts by mass (80 parts by mol) of 9,9-bis[4-(2-hydroxyethoxy)phenyl]fluorene (hereinafter, frequently referred to simply as “BPEF”), 21.64 parts by mass (101 parts by mol) of diphenyl carbonate (hereinafter, frequently referred to simply as “DPC”), and 8.40×10⁻⁵ part by mass (1.00×10⁻³ part by mol) of sodium hydrogencarbonate in a concentration of 60 mmol/L as a catalyst were charged, and the resultant mixture was melted by heating to 180° C. in a nitrogen atmosphere. Then, the degree of vacuum was adjusted to 20 kPa over 5 minutes. The temperature was increased to 250° C. at a temperature increase rate of 60° C./hr, and, after the discharge amount of phenol became 70%, the pressure was reduced at 60 kPa/hr, and a polymerization reaction was conducted until the electric power reached a predetermined value, and, after completion of the reaction, the resin was removed from the flask. The obtained polycarbonate resin was analyzed by ¹H NMR, and it was found that the 10,10′-bis(2-hydroxyethoxy)-9,9′-biphenanthrene component was introduced in an amount of 20 mol %, based on the total mole of the monomers. Using the obtained polycarbonate resin, a copolymerization ratio, a refractive index, an Abbe number, a Tg, and a light transmittance at 360 nm and 500 nm were evaluated, and the results were shown in Table 1.

### Example 2

A polycarbonate resin was produced in substantially the same manner as in Example 1 except that the respective amounts of BHEBPhe and BPEF were changed to those shown in Table 1. Using the produced polycarbonate resin, a copolymerization ratio, a refractive index, an Abbe number, a Tg, and a light transmittance at 360 nm and 500 nm were evaluated, and the results were shown in Table 1.

### Example 3

A polycarbonate resin was produced in substantially the same manner as in Example 1 except that the amount of BHEBPhe was changed to that shown in Table 1. Using the produced polycarbonate resin, a copolymerization ratio, a refractive index, an Abbe number, a Tg, and a light transmittance at 360 nm and 500 nm were evaluated, and the results were shown in Table 1.

### Example 4

A polyester carbonate resin was produced in substantially the same manner as in Example 1 except that BHEBPhe, 2,2′-bis(2-hydroxyethoxy)-1,1′-binaphthyl (hereinafter, frequently referred to simply as “BHEB”), and 2,2′-bis(carboxymethoxy)-1,1′-binaphthyl (hereinafter, frequently referred to simply as “BCMB”) were used in the respective amounts shown in Table 1, that the amount of DPC was changed to 4.50 parts by mass (21 parts by mol), and that 3.4×10⁻³ part by mass (1.00×10⁻² part by mol) of titanium tetrabutoxide was used as a catalyst. Using the produced polyester carbonate resin, a copolymerization ratio, a refractive index, an Abbe number, a Tg, and a light transmittance at 360 nm and 500 nm were evaluated, and the results were shown in Table 1.

### Comparative Examples 1 to 3

The composition in Example 1 was changed as shown in Table 1, and pellets of polycarbonate resins in Comparative Examples 1 to 3 were obtained. Using the obtained polycarbonate resins, a copolymerization ratio, a refractive index, an Abbe number, a Tg, and a light transmittance at 360 nm and 500 nm were evaluated, and the results were shown in Table 1.

With respect to the obtained thermoplastic resins, evaluation was made in accordance with the the methods described below.

### <Copolymerization Ratio>

The obtained resin was subjected to ¹H NMR measurement using JNM-ECZ400S, manufactured by JEOL Ltd., and a compositional ratio of each polymer was calculated. CDCl₃ was used as a solvent.

### <Optical Properties>

### (Refractive Index)

With respect to each polymer, a test specimen having a thickness of 3 mm was prepared and polished and then, using Kalnew precision refractometer KPR-2000, manufactured by Shimadzu Corporation, a refractive index nd (587.56 nm) at 20° C. was measured.

### (Abbe Number)

An Abbe number was determined by making a calculation from refractive indexes at a measurement wavelength of 486.13 nm, 587.56 nm, and 656.27 nm using the following formula.

νd=(nd−1)/(nF−nC)
nd: means a refractive index at a wavelength of 587.56 nm,
nF: means a refractive index at a wavelength of 486.13 nm,
nC: means a refractive index at a wavelength of 656.27 nm.

### (Absolute Value of Orientation Birefringence)

The thermoplastic resin was dissolved in methylene chloride, and then cast on a glass petri dish and satisfactorily dried to prepare a cast film having a thickness of 100 μm. The film was two-fold stretched at Tg+10° C., and a phase difference (Re) at 589 nm of the resultant film was measured using Ellipsometer M-220, manufactured by JASCO Corporation, and an absolute value of an orientation birefringence (|Δn|) was determined from the following formula.

|Δn|=|Re/d|

Δn: Orientation birefringence

Re: Phase difference (nm)

d: Thickness (nm)

### (Light Transmittance)

6.7 mg of the obtained resin was dissolved in 5 mL of dichloromethane (specific gravity: 1.33 g/mL) to prepare a 0.1% by mass solution. With respect to the prepared solution, a transmittance at 250 to 780 nm was measured using Spectrophotometer Model U-3310, manufactured by Hitachi, Ltd.

### <Glass Transition Temperature (Tg)>

A glass transition temperature of the obtained resin was measured by Discovery Model DSC25Auto, manufactured by TA Instruments Japan Inc., at a temperature increase rate of 20° C./min. 5 to 10 mg of a sample was subjected to measurement.

### «Results»

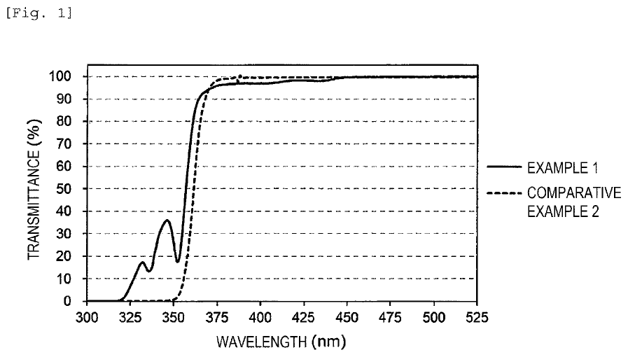

The results of the evaluation for the examples concerning the thermoplastic resin are shown in Table 1. Further, transmission spectra of 0.1% by mass dichloromethane solutions of the thermoplastic resins in Example 1 and Comparative Example 2 are shown in FIG. 1.

TABLE 1

| | Copolymerization ratio (mol %) | | | | | Results of evaluation | | | | | |
|---|---|---|---|---|---|---|---|---|---|---|---|
| | | | | | Dicarboxylic | Refractive | Abbe | | | Transmittance | |
| | Diol | | | | acid | index | number | Tg | \|Δn\| | (%) | |
| | BHEBPhe | BPEF | BHEB | BHEB6 | BCMB | nd | νd | ° C. | ×10⁻³ | 360 nm | 500 nm |
| Example 1 | 20 | 80 | | | | 1.654 | 21 | 150 | 1.0 | 74 | 100 |
| Example 2 | 50 | 50 | | | | 1.676 | 19 | 154 | 1.2 | 72 | 100 |
| Example 3 | 100 | | | | | 1.711 | 17 | 160 | 1.5 | 71 | 100 |
| Example 4 | 40 | | 20 | | 40 | 1.696 | 17 | 152 | 0.6 | 72 | 100 |
| Comparative | | | 100 | | | 1.667 | 19 | 115 | 0.2 | 97 | 100 |
| Example 1 | | | | | | | | | | | |
| Comparative | | 80 | | 20 | | 1.654 | 21 | 147 | 1.1 | 36 | 100 |
| Example 2 | | | | | | | | | | | |
| Comparative | | | | 100 | | 1.703 | 16 | 162 | 0.6 | 35 | 100 |
| Example 3 | | | | | | | | | | | |

In Examples 1 to 4, each of which uses BHEBPhe, it is apparent that such excellent results for an optical lens were obtained that the resin had high refractive index and low Abbe number.

Further, when a comparison is made between Example 1 and Comparative Example 2, both of which use a structure in which the number of aromatic rings is increased by one from that for the binaphthalene in Comparative Example 1, it is apparent that an increase of the absorption wavelength was suppressed in Example 1.

The polarizability can be increased by having a polycyclic aromatic hydrocarbon having three or more benzene rings condensed, such as the repeating units of the formula (1), and such a polycyclic aromatic hydrocarbon is effective in achieving both high refractive index and high Abbe number.

### INDUSTRIAL APPLICABILITY

The thermoplastic resin of the present invention is used in optical materials, and can be used in optical members, such as an optical lens, a prism, an optical disc, a transparent conductive substrate, an optical card, a sheet, a film, an optical fiber, an optical film, an optical filter, and a hard coat film, and particularly is extremely useful as an optical lens.

1. A thermoplastic resin having repeating units represented by the following formula (1): 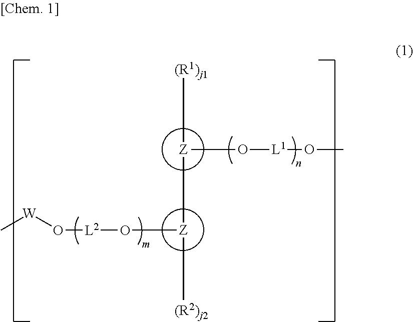
wherein Z is a polycyclic aromatic hydrocarbon having three or more benzene rings condensed, each of L¹ and L² independently represents a divalent linking group, each of R¹ and R² independently represents a hydrogen atom, a halogen atom, or a substituent having 1 to 20 carbon atoms and optionally containing an aromatic group, each of j1 and j2 independently represents an integer of 1 or more, each of m and n independently represents 0 or 1, and W is at least one selected from the group represented by the following formulae (2) and (3): 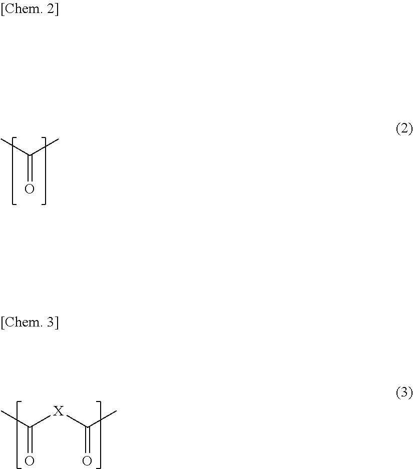
wherein X represents a divalent linking group.

2. The thermoplastic resin according to claim 1, wherein, in the formula (1), Z is a polycyclic aromatic hydrocarbon of a phenacene type.

3. The thermoplastic resin according to claim 1, wherein, in the formula (1), Z is a polycyclic aromatic hydrocarbon having three or four benzene rings condensed.

4. The thermoplastic resin according to claim 1, wherein, in the formula (1), Z is phenanthrene.

5. The thermoplastic resin according to claim 1, wherein the repeating units represented by the formula (1) are represented by the following formula (4): 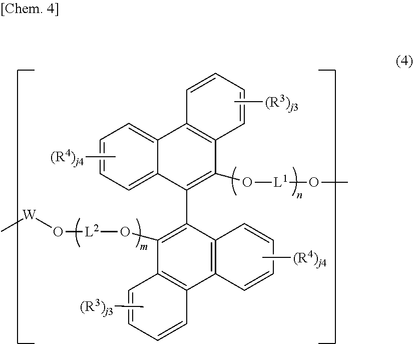
wherein each of L¹ and L² independently represents a divalent linking group, each of R³ and R⁴ independently represents a hydrogen atom, a halogen atom, or a substituent having 1 to 20 carbon atoms and optionally containing an aromatic group, each of j3 and j4 independently represents an integer of 1 or more, each of m and n independently represents 0 or 1, and W is at least one selected from the group represented by the formulae (2) and (3).

6. The thermoplastic resin according to claim 1, wherein, in the formula (1), each of R¹ and R² independently represents a hydrogen atom, a methyl group, a phenyl group, or a naphthyl group.

7. The thermoplastic resin according to claim 5, wherein, in the formula (4), each of R³ and R⁴ independently represents a hydrogen atom, a methyl group, a phenyl group, or a naphthyl group.

8. The thermoplastic resin according to claim 1, wherein X in the formula (3) is at least one selected from the group consisting of a phenylene group, a naphthalenediyl group, a group represented by the following formula (5), and a group represented by the following formula (6) and contained as the repeating units: 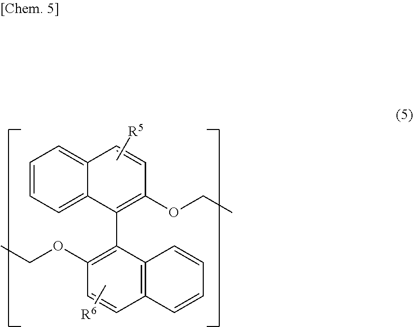
wherein each of R⁵ and R⁶ is independently a hydrogen atom, a substituent having 1 to 20 carbon atoms and optionally containing an aromatic group, or a halogen atom,

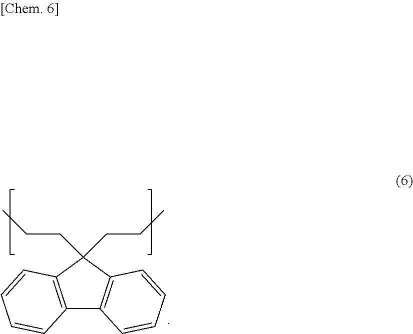

9. The thermoplastic resin according to claim 1, which has at least one unit selected from the group consisting of units represented by the following formulae (7) to (10) as the repeating units: 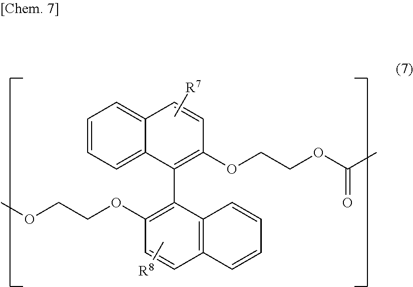
wherein each of R⁷ and R⁸ is independently a hydrogen atom, a substituent having 1 to 20 carbon atoms and optionally containing an aromatic group, or a halogen atom, 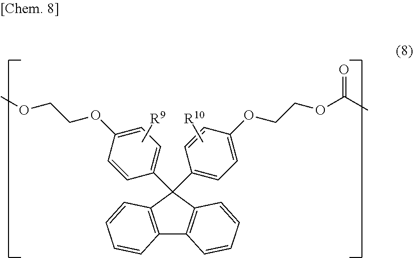
wherein each of R⁹ and R¹⁰ is independently a hydrogen atom, a substituent having 1 to 20 carbon atoms and optionally containing an aromatic group, or a halogen atom, 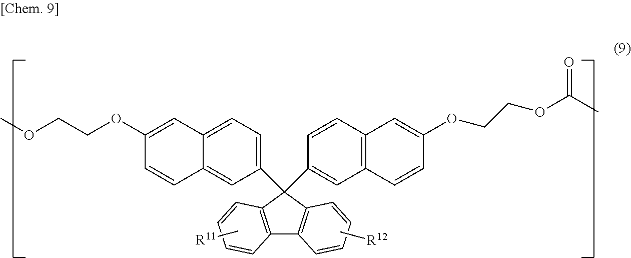
wherein each of R¹¹ and R¹² is independently a hydrogen atom, a substituent having 1 to 20 carbon atoms and optionally containing an aromatic group, or a halogen atom, 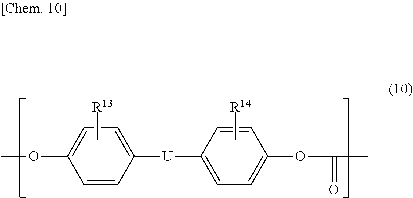
wherein each of R¹¹ and R¹⁴ is independently a hydrogen atom, a substituent having 1 to 20 carbon atoms and optionally containing an aromatic group, or a halogen atom, and U is a single bond or a divalent linking group.

10. The thermoplastic resin according to claim 1 which has a refractive index of 1.65 to 1.80.

11. The thermoplastic resin according to claim 1, which has a specific viscosity of 0.12 to 0.40.

12. The thermoplastic resin according to claim 1, which has a glass transition temperature of 130 to 170° C.

13. An optical member comprising the thermoplastic resin according to claim 1.

14. The optical member according to claim 13, which is an optical lens.
